(19) United States
(12) Patent Application Publication
(10) Pub. No.: US 2008/0123834 A1
(43) Pub. Date: May 29, 2008

(54) Automatic Foreign Exchange Consolidation

(76) Inventors: Sam Brown, Columbia, MD (US); Laurence C. Rubin, Silver Spring, MD (US)

Correspondence Address: Laurence C. Rubin, 4 Fulham Court, Silver Spring, MD, 20902-3016, US

(21) Appl. No.: 11/563,203

(22) Filed: Nov. 26, 2006

(51) Int. Cl. H04M 7/00

(52) U.S. Cl. 379/221.02

(57) ABSTRACT

This is a method for a LEC or IXC to provide the geographically appropriate calling party telephone number to the called party with such method being transparent to the calling party.

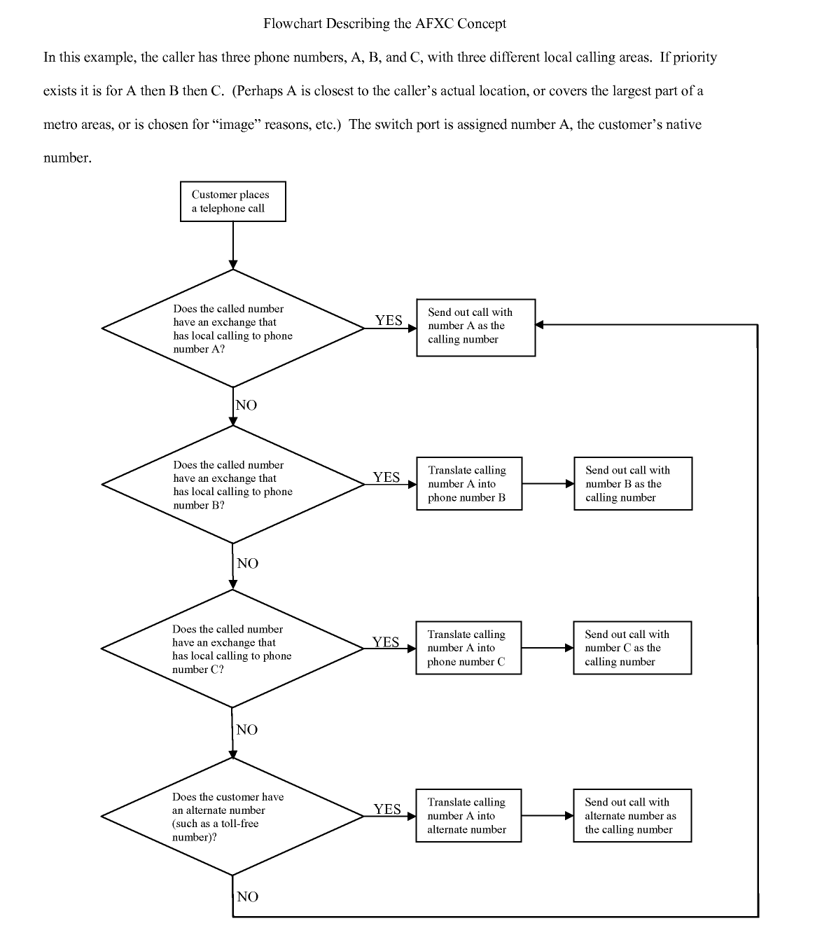

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

A. Field of the Invention

This invention relates to voice telecommunications, specifically to a method of enlarging local calling areas.

B. Definition of Terms

The term “AFXC” refers to the name of the invention, Automatic Foreign Exchange Consolidation.

The term “dialtone service” refers to the physical or virtual connection of the customer's telephone to a LEC, cellular carrier, or VoIP provider, and all necessary facilities to provide such service, regardless of whether an actual dialtone is heard or not.

The term “LEC” refers to local exchange carrier, which is a telecommunications company that has the ability to obtain its own telephone exchanges. Many LEC's also provide the dialtone service to the customer, but that service is not specifically required to implement this invention. A LEC can also offer IXC services.

The term “IXC” refers to interexchange carrier, which is a telecommunications company that provides telecommunications services such as, but not limited to, the carrying of long-distance calls, but does not necessarily provide the dialtone service to the customer.

The term “exchange” refers to a group of telephone numbers assigned by the LEC to customers within geographical boundaries and provides local calling to the surrounding geographical area, as defined by the LEC.

The term “standard line” refers to the exchange assigned to the dialtone service to provide the customer with local calling to the surrounding geographical area, as defined by the LEC.

The term “FX” or “foreign exchange” refers to an exchange assigned to a customer where the exchange provides local calling to a different geographical area, as defined by the LEC.

The term “message unit” refers to a fixed charge by the LEC imposed on certain classes of customers for each telephone call the LEC classifies as local, regardless of duration.

The term “local measured service” refers to a time-based charge by the LEC imposed on certain classes of customers for each telephone call the LEC classifies as local, and is based on the duration of the call.

The term “local call” refers to the group of exchanges as defined by the LEC to which a customer can place a call to which no extra charges apply, or a message unit charge applies, or local measured service applies.

The term “local calling area” and “LCA” refers to the geographic area to which local calls may be made.

The term “toll” refers to a charge to the customer based on the amount of time elapsed for those telephone calls the LEC does not classify as local calls.

The term “long-distance” or “toll call” refers to a type of telephone call that incurs toll charges.

The term “community” refers to a city, town, combination of adjacent cities or towns, or any other inhabited location, whether or not incorporated and with or without its own government structure.

The term “switch” refers to a telecommunications device designed to channel incoming signals (which can be, though not limited to, voice, data and video) from its inbound ports to the specified outbound port so that the signal reaches its destination. The switch is usually programmable and customizable.

The term “translation” refers to converting one telephone number into another telephone number.

The term “routing” refers to the pre-programmed determination of which port an incoming telecommunications signal uses to exit the switch, based on the called and/or calling number.

The term “native” or “native number” refers to the number directly associated with the customer's telephone service. This is, in the absence of AFXC, the only number that would be considered the number for the particular line. In DID arrangements, this would refer to the range of numbers directly assigned to the customer's trunks or PRI's. The native number may be standard or FX, and would typically be representative of the number which the customer already had before implementation of AFXC, the number associated with the most-called place, or most closely representative geographically of the customer's physical location.

The term “switchless resale” refers to a telecommunications service provider that does not have its own equipment but instead arranges to use equipment of other LEC's and/or IXC's to provide their services.

The term “caller ID” refers to a service offering whereby the subscribing customer receives the telephone number and in some cases also the name of the calling party on a display unit (which for purposes of this definition also means a speaking unit that might for instance be made available to the visually impaired) connected to the customer's telephone line, which may be a stand-alone unit or a display integrated as part of the telephone itself or on the customer's computer, mobile telephone, pager, or any other apparatus. Such service includes the service branded as “caller ID” by some LEC's as well as any other method that achieves the same results insofar as providing the aforementioned calling party identification information including, but not limited to, “return call” whereby a customer can obtain the calling party's information by telephone using a special key sequence defined by the LEC.

The term “VoIP” refers to voice telecommunications routed fully or partially over the internet, or making use of IP (internet protocol) on a private network.

The term “FG-D” refers to a Feature Group D circuit that is a connection on which a dialtone-providing LEC passes calls to a customer's chosen IXC, when those calls are not defined as local by the LEC. (Local calls are carried directly by the LEC).

C. Description of Related Art

Historically, a customer desiring voice telephone service would typically be assigned an exchange by the LEC based on the geographical location of the customer. The LEC would permit such exchanges to call certain other exchanges without the customer incurring toll charges. Calls placed to any other exchanges, even if to nearby communities, would incur a toll.

Due to economic and personal ties between certain communities that are a long-distance call from each other, the LEC made available foreign exchanges, which permitted a customer to obtain an exchange normally assigned to a different geographical area so that the customer's exchange is a local call to and from the exchange(s) with which the customer wishes to communicate.

At one time FX lines were expensive and in many cases unavailable for many places. However, in recent years competition has resulted in the existence of some LEC's that will provide an FX line for the same price as a standard line. Further, VoIP and newer cellular service offerings have made it possible and common to obtain an exchange from almost anywhere, regardless of distance.

Another offering is remote call forwarding, whereby a customer obtains a telephone exchange that has a different LCA and all calls made to it are forwarded to the customer's telephone line. Such an arrangement carries a fixed monthly fee plus charges for the price of calls from the forwarding arrangement to the customer's destination number.

D. Problems the Invention Attempts to Solve

FX lines provide a different local calling area but not necessarily a larger one. Further, FX lines are often not local to all, or even most, exchanges that would otherwise be local from a standard line. The result is that a customer must maintain both a standard line and an FX line in order to be a local call to and from the customer's geographical calling area as defined by the LEC plus the nearby geographical area desired by the customer. In other cases, customers use two or more FX lines to give the capability of local calling to the desired larger geographical region.

Customers desiring local calling to more locations than the standard line would otherwise provide must either purchase FX lines that provide the desired geographical coverage or purchase a long-distance calling plan at a fixed monthly charge. In either case, the cost involved can be significant. Further, the latter case does not provide an alternate telephone number that would be a local call from a larger area, thus many people needing to reach the customer would still be forced to make toll calls. These scenarios are particularly a problem for businesses desiring to establish a “local connection” with potential customers, as the perception created by a business being a local call is often important.

Some customers desiring to be a local call from certain areas pay for one or more exchanges in the form of remote call forwarding service, which adds to the cost burden, and only provides incoming local service from an LCA but not local calling service to that LCA.

Due to the necessity of maintaining both a standard line and an FX line for regional local calling, the customer, any family members, employees or anyone else wishing to place a telephone call from the customer location must choose the correct telephone line on which to place the outgoing call in order to take advantage of the potentially larger calling area afforded by the customer having a combination of telephone lines each with a different local calling area. This is a source of confusion and error, as very few people have a great enough knowledge and understanding of local calling areas to be effective at consistently using the proper line. Additionally, such an arrangement can have the effect of limiting capacity, because a caller may have to wait for the availability of a specific line (or group of lines) local to the specific destination, rather than being able to economically use any available line for an outgoing call.

If the called party has caller ID, which many individuals and businesses do, the number of the calling party displayed is presently the telephone number of the line on which the calling party has placed the call and is not necessarily the telephone number that is a local call from the called party. If the calling party chooses the incorrect telephone line to place the call (e.g. the line that incurs a toll charge to call the called party) the called party's caller ID displays that number, which is long-distance, even though the calling party possesses a telephone line which is a local call to and from the called party. Should the called party use the telephone number displayed by that party's caller ID to return the call, that party also needlessly incurs a toll charge even though a local telephone number was available.

### SUMMARY OF THE INVENTION

In an AFXC arrangement the customer's telephone line has an LCA generally including, but not limited to, the combined LCA's of the standard and FX lines the customer might otherwise desire. A customer would thereby be able to make local calls to a much larger geographical area than would otherwise be possible, all with one physical telephone line. This eliminates the need for a separate FX line and its associated cost. A customer could further have several standard telephone lines, all with the same extensive local calling characteristics. The AFXC-enabled line, instead of having only one telephone number assigned to it, would have at least two telephone numbers that are a local call from different LCA's. This eliminates the need for remote call forwarding and its associated cost.

The LEC would pre-define one or more LCA's and offer such LCA's as part of, or in addition to, its usual telephone service offerings or as a stand-alone service. Service offerings could consist of one LCA, the choice among several LCA's, or packages of two or more LCA's. The LEC would assign one or more LCA's to the customer's telephone line based on the service option the customer chose. From the customer's perspective, any call to any of the LCA's in an AFXC arrangement is a local call.

The first embodiment of the invention is that an LEC will assign one or more telephone numbers to a customer in order to enlarge the geographical area from which the customer can be reached with a local phone call. The preferred embodiment is that the LCA of the assigned telephone number or the combination of the LCA's of several telephone numbers mirrors, or is substantially equivalent to, the customer's outbound LCA. An alternate embodiment is assigning the customer inbound telephone numbers from different locations that would not necessarily mirror the customer's LCA.

These telephone numbers are inbound to the customer and are not separate physical telephone lines to the customer. This is separate and distinct from the native telephone number with which the customer's dialtone service is physically associated.

When a customer places a call, the LEC's switch looks up the LCA of the telephone number the customer is calling. The LCA lookup is a standard procedure most LEC's are presently capable of doing, and uses databases commonly available to the industry; however the present usage has been limited to how a call is routed and rated. The additional purpose of this lookup procedure, which is presently not done, is to determine whether the called party's exchange is a local call to the calling party's native number or any of the inbound numbers assigned to the calling party.

If the called party's telephone number is local to the native telephone number of the calling party, the call will go through without change and the called party's caller-ID display will show that number.

If the called party's number is not local to the calling party's native number, the LEC will determine if the customer has been assigned a telephone number that is local from the number the customer is calling. If a local number exists, the switch will automatically translate the customer's native telephone number to the appropriate assigned number, and route that information along with the telephone call on an outbound port of the LEC's switch. In this manner the called party will receive caller-ID information showing a telephone number that is local to the called party, even though the calling party's native telephone number is not local. In this manner, the called party can return the telephone call using any means, including but not limited to manually dialing the displayed number, or using a return call feature offered by many LEC's and on many caller-ID units. From the called party's perspective the displayed phone number is simply a local call.

If the called party's number is not local to the calling party's native number and the LEC has determined the customer does not have an assigned number that is local to the called party, the called party will receive on its caller-ID display a default number which may be the calling party's native telephone number or one of the calling party's pre-assigned numbers. The LEC may allow the customer to choose the default number or the LEC may retain discretion of which number to display, such as selecting a number on the basis of geographical proximity to the called party's physical location.

A second embodiment of this invention is virtual FX services. In such an arrangement, the AFXC provider is generally not the customer's local dialtone provider, or is engaging in switchless resale of local service. In these situations some or all of the customer's outgoing calls are routed to the AFXC provider by means of dial-in numbers, VoIP, FG-D, or calling-card type access.

For receiving calls the customer is issued one or more forwarding numbers that have exchanges that are local from places where the customer's standard phone number would be long-distance. These additional numbers are translated and forwarded to the customer's actual dialtone number, so that calls to any of these forwarding numbers will reach the customer on the customer's physical telephone line. When the customer makes calls to numbers that are local from one of the assigned forwarding numbers but are not local to the customer's native number, the forwarding number that is local to the called party is the number is sent as the calling number.

### DETAILED DESCRIPTION OF THE INVENTION

A customer will obtain a physical dialtone line from the LEC, or have the existing native service enhanced by AFXC. The customer's telephone service provider that offers AFXC, which can be a LEC, an IXC, or any other telephone service provider capable of telephone number translation, will provide the customer with one or both of the following:
A. An outbound calling area considered as a local call to a geographic region such that more than one telephone exchange would normally be required to cover the area. This can be accomplished by the AFXC provider programming into its rating tables a rate plan designed to treat all outbound calls as local calls.

Such programming is done on the specific hardware the AFXC provider is using and though the sequence of steps needed to create such a rate plan differ from hardware platform to hardware platform, the concept of building such a rating structure would be able to be accomplished by any programmer proficient with the particular hardware involved in the rating of outbound telephone calls.
B. One or more inbound telephone numbers would be used, such that they are locally reachable from a larger geographical area than the customer's native number. Such inbound numbers may be assigned by the AFXC provider by using its own exchanges, or by using direct inward dial telephone numbers, or by using remote call forwarding numbers, or a combination of these such that the inbound telephone numbers assigned to the customer are a local call from as much as the customer's desired geographical area as possible. The AFXC provider will program these numbers into its switch such that any calls made to those numbers will ring on the customer's native telephone line. The steps to program the switch varies across hardware platforms, but the concept of being able to translate inbound numbers to route to other telephone numbers exists on essentially all switch platforms.

Upon the customer placing the outbound call, the AFXC provider will determine whether the called number is local from one of the inbound telephone numbers assigned to the customer. In the flowchart example, the customer has a native number with exchange A, and two assigned inbound numbers with exchanges B, and C. The switch looks up the dialed exchange in its routing tables to determine if exchanges A, B, or C are a local call from the called number.

AFXC makes use of this information in a new and novel way in to determine which telephone number to send to the called party.

If the routing tables contain information indicating that the AFXC customer has a number that is local from the number that the AFXC customer is calling, the switch will send the data stream containing the appropriate local number such that the recipient is given a telephone number that is a local call from the recipient. If the answer is no, that there is no customer-assigned number local from the called party, the switch will send the data stream containing the customer's native number or any other number owned by the customer (such as a toll-free), at the customer's preference.

The data stream containing the called number is sent through the national telephone network, or VoIP, using industry standard data format and signaling with the benefit of AFXC's ability to send the calling party's number that changes based on the location of the called number, and simulates the condition of the customer having standard and/or FX line(s) as needed, with the right line being selected for each call.

The end result is that the AFXC user may place outbound calls without needing to be concerned about which telephone line to use, and the call recipient will receive the calling party number that is appropriate to the recipient's geographical location.

It should be noted that while generally AFXC will be used to send whatever number is local to the customer, in some situations a particular number might be used for a larger region. For example, this could occur when a business used AFXC for the combining of numbers in communities generally associated with different metropolitan regions. The customer may find it desirable, for reasons of image or marketing, to send an in-region or closer-to-region number even to places where it does not have a local number. Ultimately, AFXC can be used to send the number best suited to be sent to any calling location, though we use term “local” in place of “appropriate” in this application, for the sake of simplicity and to represent the typical application.

We claim:

1. A method to provide the full inbound and outbound functionality of standard phone service and FX phone service(s) on a single or on each line of a multi-line arrangement, comprising the steps of:
a. assigning one or more LCA's to a customer's telephone line such that the LCA or combination of LCA's best serves the geographical local calling needs of the customer, and
b. assigning one or more telephone numbers to the customer such that a local inbound telephone number exists for most or all locations within the customer's LCA or within the customer's desired area(s) from which to be local, and
c. for outgoing calls the switch will determine whether such outgoing call is to a telephone number which has local calling to a telephone number assigned to the customer, and
d. if such a corresponding number exists the switch will translate the calling party's telephone number into the local number such that the local number is the one sent as the calling number, such that it may be shown on the called party's caller-ID display, or could be used by any available call-back features that the recipient may have.

2. A method to provide full inbound functionality of standard phone service and FX phone service(s) on a single or on each line of a multi-line arrangement, comprising the steps of:
a. assigning one or more telephone numbers to the customer such that a local inbound telephone number exists for all locations within the customer's desired area from which to be local, and
b. the switch will determine whether an outgoing call is to a telephone number which is a local call to a corresponding telephone number assigned to the customer, and
c. if such a corresponding number exists the switch will translate the calling party's telephone number into the local number such that the local number is the one sent as the calling number, such that it may be shown on the called party's caller-ID display, or could be used by any available call-back or other calling-number-based features that the recipient may have.
